(19) United States
(12) Patent Application Publication
(10) Pub. No.: US 2024/0193566 A1
(43) Pub. Date: Jun. 13, 2024

(54) DISTRIBUTED E-COMMERCE SYSTEM USING A TOKENIZED PROOF-OF-POSITION (TPP)

(71) Applicants: Torbjor Anderson, Highland, UT (US); Per Anderson, Highland, UT (US)

(72) Inventors: Torbjor Anderson, Highland, UT (US); Per Anderson, Highland, UT (US)

(21) Appl. No.: 18/534,280

(22) Filed: Dec. 8, 2023

Related U.S. Application Data
(60) Provisional application No. 63/431,365, filed on Dec. 9, 2022.

(51) Int. Cl. G06Q 20/12; G06Q 20/10; G06Q 20/38

(52) U.S. Cl. CPC G06Q 20/123; G06Q 20/108; G06Q 20/389

(57) ABSTRACT

Described is a distributed e-commerce system using a tokenized proof-of-position (TPP) that operates within a blockchain. The blockchain includes a plurality of nodes that, in the aggregate, allow for operation of an e-commerce store through smart contracts that issue customer, funder, and affiliate TPPs. An item ordered is represented as a TPP in combination with a smart contract that holds the customer's funds in an escrow until the customer's TPP is canceled or redeemed for the product. Funders can provide liquidity to a store, if needed, to produce the product for the consumer for a return on their investment paid directly from the funds in escrow when the customer TPP is redeemed. Separately, affiliates can market the product and receive a TPP representing their commission on the sale. Redemption of the respective TPP results in shipment of the product, payment of the funder's investment, or payment of the affiliate commission.

### CROSS-REFERENCE TO RELATED APPLICATIONS

This is a non-provisional application of U.S. Provisional Application No. 63/431,365, filed on Dec. 9, 2022, the entirety of which is incorporated herein by reference.

### BACKGROUND OF INVENTION

### (1) Field of Invention

The present invention relates to e-commerce systems and, more specifically, to a distributed and decentralized blockchain e-commerce system platform that uses a non-fungible token (NFT) as a redeemable representation of a position in escrow created exclusively for a single transaction.

### (2) Description of Related Art

Some of the most difficult aspects of e-commerce are maintaining cash flow, securing funding for production, and marketing the items. Pitfalls for the consumer are fake reviews, locking up a substantial sum of money on a pre-ordered item or difficulty getting a full refund if the vendor were to cancel an order. Trust and funding issues are common problems in commerce and project development. Addressing trust and project development costs are review sites and various lender options, respectively. However, reviews alone do little to provide transparency and do not assist in funding project development. Further, traditional lending processes are antiquated and often not integrally tied to micro-funding or micro-projects.

Thus, a continuing need exists for an improved e-commerce system that brings together funders, retailers, affiliates and consumers while avoiding the issues of existing systems.

### SUMMARY OF INVENTION

The present disclosure provides a distributed e-commerce system using a tokenized proof-of-position (TPP). The e-commerce system comprises one or more processors and associated memory. Each of the processors operates as a node within a blockchain system. Each memory is a non-transitory computer-readable medium having executable instructions encoded thereon, such that upon execution of the instructions, the one or more processors, in the aggregate, perform several operations, including: creating, by a Main Contract, a Store Vault, a Funding Vault, and a Store Contract for an e-commerce store; receiving, in the Main Contract, predefined terms of a fundable project by a company; generating, by the Store Contract, a first TPP Contract; receiving, in the Main Contract, an order by a first party for the fundable project; generating, by the Store Contract, an Order Escrow Contract for the order; and generating, by the first TPP Contract, a first TPP for the first party. As noted above, the one or more processors perform the listed operations in the aggregate, meaning that one node, in of itself does not necessarily need to complete all listed operations so long as the collection of nodes (one or more processors) in blockchain perform the listed operations.

In another aspect, the system one or more processors (or nodes) further perform operations of receiving funding, by at least one second party, funds for completion of the fundable project per predefined investment terms; generating, by a second TPP Contract, a second TPP for the at least one second party; and transmitting the funds to a Funded Vault associated with the company.

In yet another aspect, the order is a pre-order for a product, the first party is a consumer, and the at least one second party is a funder, the funder providing funds for completion of the pre-order.

In yet another aspect, the consumer placed the order through an internet link to the Main Contract as placed by a third-party affiliate, such that upon generation of the Order Escrow Contract for the order, a third TPP is generated for the third-party affiliate.

In another aspect, upon completion of the predefined terms of the fundable project, redeeming one or more of the first, second and third TPPs.

Further, upon redemption of the first TPP, instructions are provided to the company to ship the product to the consumer.

Additionally, upon redemption of the second TPP, transmitting a funder payment to the funder per the predefined investment terms.

The distributed e-commerce system using the TPP as set forth in claim 7, wherein upon redemption of the third TPP, transmitting a affiliate payment to the third-party affiliate per predefined terms of the third TPP.

Finally, the present invention also includes a computer program product and a computer implemented method. The computer program product includes computer-readable instructions stored on one or more non-transitory computer-readable medium that are executable by one or more computers having one or more processors, such that upon execution of the instructions, the one or more processors, in the aggregate, perform the listed operations. Alternatively, the computer implemented method includes an act of causing one or more computers (i.e., nodes within the blockchain) to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of an e-commerce system according to various embodiments of the present invention;

FIG. 2 is an illustration of a computer program product embodying an aspect of the present invention;

FIG. 3 is a flowchart depicting a store creation and product collection process according to various embodiments of the present invention;

FIG. 4 is a flowchart depicting an order and tokenized-proof-of-position (TPP) generation process according to various embodiments of the present invention;

FIG. 5 is a flow chart depicting a TPP redemption process according to various embodiments of the present invention;

FIG. 6 is a flow chart depicting a TPP refund process according to various embodiments of the present invention;

FIG. 7 is a block diagram depicting control of a device according to various embodiments.

### DETAILED DESCRIPTION

The present invention relates to e-commerce systems and, more specifically, to a distributed and decentralized blockchain e-commerce system that extends non-fungible tokens (NFT) as redeemable representations of various positions in an escrow created exclusively for a single transaction, the NFT being referred to as a tokenized proof-of-position (TPP). The following description is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112(f). In particular, the use of “step of” or “act of” in the claims herein is not intended to invoke the provisions of 35 U.S.C. 112(f).

Before describing the invention in detail, first a description of the various principal aspects of the present invention is provided. Subsequently, an introduction provides the reader with a general understanding of the present invention. Finally, specific details of various embodiment of the present invention are provided to give an understanding of the specific aspects.

### (1) Principal Aspects

Various embodiments of the invention include three “principal” aspects. The first is an e-commerce system. The e-commerce system is provided as a blockchain-based e-commerce application consisting of Smart Contracts and is typically in the form of one or more computer systems (nodes) operating software or in the form of a “hard-coded” instruction. The system can be deployed on a blockchain system consisting of nodes. Thus, the system may be incorporated into a wide variety of devices that provide different functionalities. The second principal aspect is a method, typically in the form of software, operated using one or more data processing systems (computers as nodes in the blockchain). The third principal aspect is a computer program product. The computer program product generally represents computer-readable instructions stored on one or more non-transitory computer-readable medium, such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

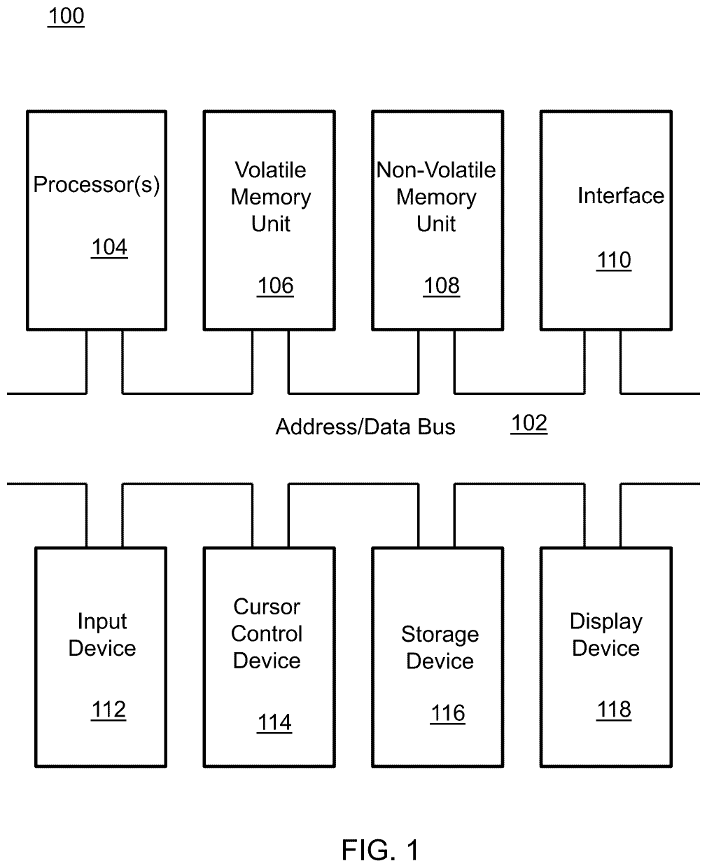

As noted above and in one aspect, the e-commerce system is a distributed and decentralized application that is comprised of one or more smart contracts that is executed on nodes. A block diagram depicting an example of one node (i.e., computer system 100) of the e-commerce system of the present invention is provided in FIG. 1. The e-commerce system includes any computers systems 100 (i.e., nodes) and associated executable code (as stored on one or more computer readable medium) as necessary to implement the distributed blockchain and smart contract processes as described and illustrated. Each node or computer system 100 is configured to perform calculations, processes, operations, and/or functions associated with a program or algorithm. Thus, it should be noted that although a single computer system 100 is depicted, the invention is not intended to be limited thereto as it can be spread out amongst several systems 100 that collectively operate to perform the functions and operations as described herein. For example and as understood by those skilled in the art, the e-commerce system operates across many processors and computer systems 100.

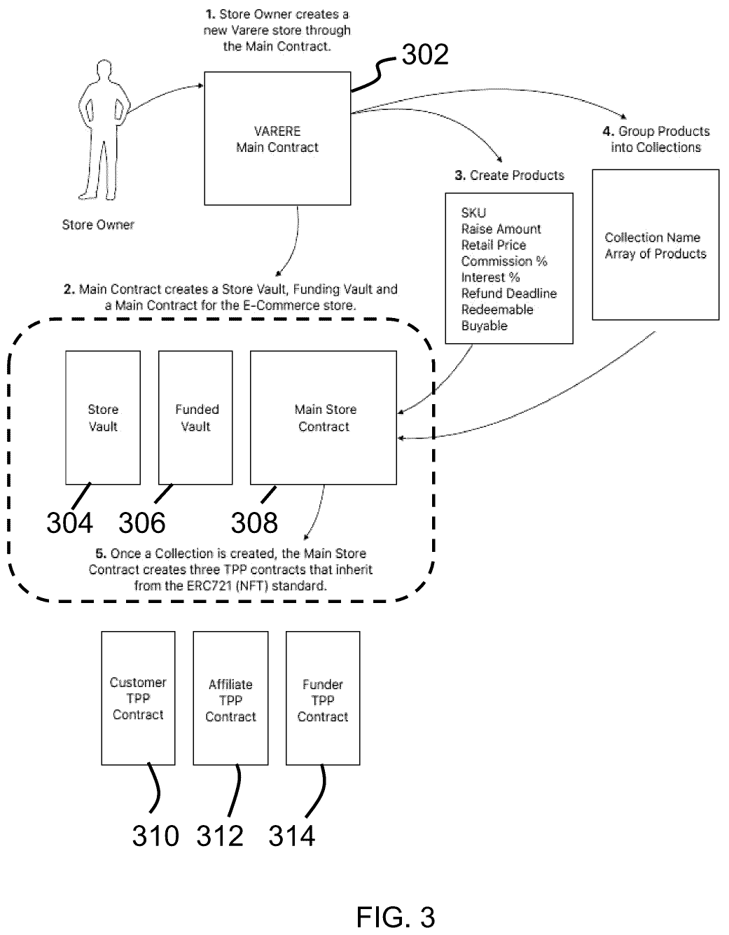

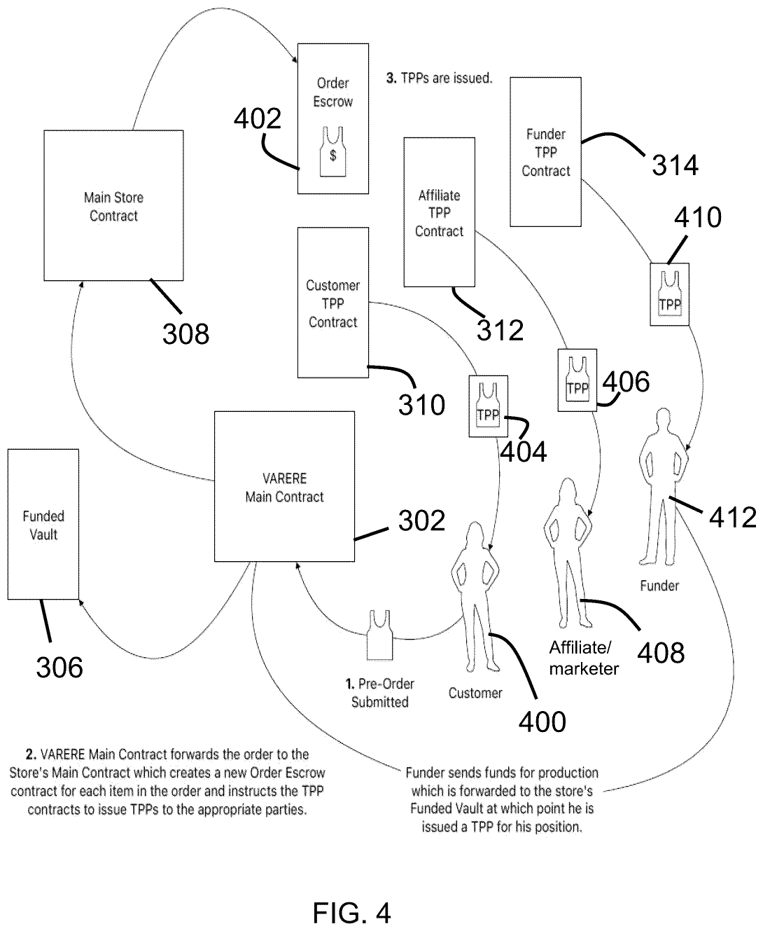

In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as those described and illustrated (e.g., see FIGS. 3 through 7). In various aspects, the computer system 100 can be embodied in any device(s) that operates to perform the functions as described herein as applicable to the particular application, such as a desktop computer, a mobile or smart phone, a tablet computer, a computer embodied in a mobile platform, or any other device or devices that can individually and/or collectively execute the instructions to perform the related operations/processes (such as those as illustrated in FIGS. 3 and 4). In some aspects, in a blockchain setup, individual processors (i.e., the one or more processors) may have various smart contracts that individually perform portions of the listed operations; however, in the aggregate, they all perform the listed operations.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA) or any other processing component operable for performing the relevant operations.

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, mobile wireless networks, etc.) communication technology. Further, one or more processors 104 (or devices, such as funder, customer, and retailer mobile devices, etc.) can be associated with one or more associated memories, where each associated memory is a non-transitory computer-readable medium. Each associated memory can be associated with a single processor 104 (or device), or a network of interacting processors 104 (or devices).

In one aspect, the computer system 100 may include an input device 112 coupled with the address/data bus 102, wherein the input device 112 is configured to communicate information and command selections to the processor 104. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 104. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer or across computers (nodes) in the blockchain. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments (i.e., to implement a blockchain), such as where tasks are performed by remote processing devices that are linked through a communications network, or such as where various program modules are located in both local and remote computer-storage media including memory-storage devices.

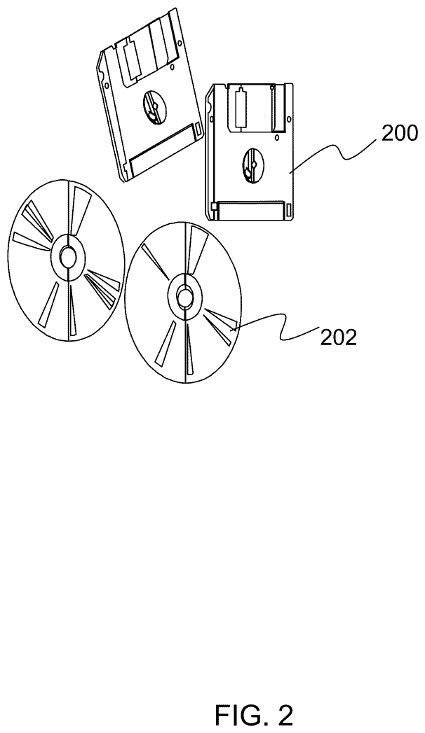

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules (or smart contracts as implemented in the blockchain and distributed across several devices or computer systems). Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

### (2) Introduction

Some of the most difficult aspects of e-commerce are maintaining cash flow, securing funding for production and marketing the items. Pitfalls for the consumer are fake reviews, locking up a substantial sum of money on a pre-ordered item or difficulty getting a full refund if they were to cancel an order. The system of the present disclosure addresses these issues by providing a novel extension of the non-fungible token (NFT) as a redeemable representation of the right to claim a portion of a given transaction, referred to as a tokenized proof-of-position (TPP) in relation to a separate contract acting as escrow. Thus, this invention enables the implementation of transparent, distributed and decentralized blockchain e-commerce systems where all parties involved in a transaction hold digital positions that can be traded, swapped or sold.

In one aspect, the invention provides a blockchain-based Web3 E-Commerce platform that facilitates transparent, decentralized crowd funding for the production of individual items/goods represented by TPPs, distributed marketing and resale of goods by any individual represented by TPPs (through a registered alias or the affiliates wallet address), building of personalized, sharable catalogs from the selection of items across multiple stores and the customer's right to a refund or delivery of a given item represented by TPPs. Basically, the invention provides decentralized and distributed e-commerce.

Production might be handled by the store. Marketing and resale can be handled by individuals, such as marketers/influencers, who build a catalog (e.g., such as via Pinterest or any other online platform). Funding for production is crowd sourced via NFTs (or otherwise referred to as TPP) on a per item basis. In some aspects, no banks are needed. In one example implementation, only the wallet address that redeemed the customer's TPP for a product can leave a review for that product. Stores might offer a few bucks back as a reward to customers who leave a review. For example, “bucks back” can be a reward in crypto currency that would be made withdrawal-able. The system can also include an on-chain layaway system so customers can buy-now-pay-later. Customers would need to pay off their loan to be granted ownership of the TPP before they could redeem that TPP for a physical product.

A way to represent an individual order/transaction for an item sold is issued as a TPP in combination with a smart contract that holds the customer's funds in an escrow until the customer's TPP is canceled or redeemed. The transparent nature of the blockchain allows anyone to see that an item represented by a TPP has actually been ordered and funds are held in escrow awaiting redemption of the TPP. Individual funders can then provide liquidity to a store, if needed, to produce/manufacture/deliver said product to the consumer for a return on their investment paid directly from the funds in escrow the moment the TPP is redeemed. This mechanism keeps the customer's funds safe while providing immediate liquidity to the store at the sole risk of the funder. The holder of the customer TPP may cancel the order for a full refund, swap/trade/sell the TPP, borrow against the TPP or ultimately redeem the TPP for the product or service it represents. The funder, if any, is free to swap/trade/sell their position as well because that position is represented as a TPP.

Individuals promoting a product from a store that can be directly linked to the sale of the TPP via a registered alias or their wallet address etc., are entitled to a portion of the funds held in escrow as well. The escrow contract manages distribution of the funds from escrow sending the store it's net proceeds due and securely holding the affiliate and funders portions until redeemed. Essentially crowd-sourcing the business functions of financing and marketing of any products while securely managing compensation on a per transaction basis.

Byproducts of the invention are immutable transparent orders, transparent financials of historical transactions by a store and reviews mapped directly to the wallet of the individual who redeemed the TPP as recorded and verified on the blockchain. By providing only legitimate reviews and actual sales numbers, bad actors are quickly identified either by failure to deliver products or by delivering less than satisfactory products. Individuals are incentivized to promote other store's products for a commission. Store's are incentivized to quickly manufacture and deliver products to maximize profit. If a transaction fee is incurred, the customer is disincentivized to redeem their TPP for a refund. In all three cases each position is represented as a TPP, which is based on the ERC721 standard, can be swapped/traded/sold in an NFT marketplace. Further details regarding the invention are provided below.

### (3) Specific Details of Various Embodiments

As noted above, the present disclosure provides a distributed and decentralized e-commerce system or platform that represents individual positions for a customer, a funder and an affiliate for an item sold, issued as TPPs, in combination with a smart contract that holds the funds from the transaction in escrow until the TPPs are canceled or redeemed. The system and associated method generally proceeds through distinct blockchain processes, including (1) a store creation process, (2) an order process, (3) a redemption process, and, in some cases, (4) a refund process. Each of these processes are described in turn below.

As shown in FIGS. 3 through 6, the e-commerce system is a blockchain based system that is configured to allow a vendor to create a store to facilitate the sale of a product, compensation to affiliates for promoting the sale, a fund process by which a user of the system (funder) can fund a project (e.g., pre-order from an e-commerce store). In turn, each of the three actors in the transaction for an item receives a tokenized proof-of-position (TPP) representing their position in the order escrow.

At the outset and as shown in FIG. 3, the vendor or store owner creates a new store and store contracts through a Main Contract 302 (referred to as the VARERE Main Contract). The Main Contract 302 and all contracts as referred to herein are smart contracts. As understood by those skilled in the art, a smart contract is a script on the blockchain that executes the terms and can spawn off additional smart contracts. In this case, the Main Contract 302 can be interacted with directly or through an SDK (or other similar programming); this allows the Main Contract 302 to interface with or otherwise work with the store contracts (which exist on the same blockchain system) and/or create other smart contracts. The Main Contract 302 handles most interactions with the users, either directly or via an SDK, etc., to do such things as deploy new store contracts, add products, group products into collections, etc. The Main Contract 302 also holds global variables and utility functions.

The Main Contract 302 creates a Store Vault 304, a Funded Vault 306, and a contract for the e-commerce store (referred to as the Store Contract 308). As described in further detail below, the Store Contract 308 manages products and product collections, deploys the Customer, Affiliate and Funder TPP contracts when a product collection is created, as well as creates the Order Escrow Contract when an order is placed. The Store Vault 304 receives the net proceeds from the Order Escrow Contract. The Funded Vault 306 receives the funds sent by the Funder to the store for production of the item when an order is placed.

With the Store Contract 308 created, the store owner can input products for sale and group products into collections. In one aspect, there are eight required parameters to add a product. They are: (1) SKU (a unique String), (2) Raise Amount (the amount the store is looking to raise to produce that single item), (3) the Retail Price, (4) the commission percentage offered to affiliates (marketers), (5) the interest rate offered to funders, (6) a deadline for refunds as a date, (7) whether the product is immediately redeemable (true false) and (8) buyable (true | false). If a product is buyable and redeemable, then this is an immediate retail transaction. If a product is buyable but not yet redeemable, it is a pre-order. In other words, the store owner or user can input into the Store Contract 308 predefined terms of a fundable project (e.g., production and sale of a product) by the store or company.

With the products (and predefined terms of the fundable project) input into the Store Contract 308, the user can also create product collections. Grouping the products into collections make the items in the collection fungible with other items within the same collection. For example, a product collection can have many SKUs (e.g., different sizes, color variations of a product, etc.).

With all products assigned to a collection input into the Store Contract 308, the Store Contract 308 can then generate three TPP contracts that inherit from the ERC721 standard. As understood by those skilled in the art, ERC721 is a standard for representing ownership of non-fungible tokens (NFT), that is, where each token is unique.

Specifically, the Store Contract 308 generates a Customer TPP Contract 310, an Affiliate TPP Contract 312, and a Funder TPP Contract 314. These three TPP contracts will mint TPPs to the appropriate wallet addresses involved in the transaction whenever an item from a collection is sold. Thus, the Customer TPP Contract 310 mints a Customer TPP to represent an order of an item from a Product Collection in addition to a position for the balance of the Order Escrow in the event of a refund. Theoretically, the Customer TPP should always be worth at least as much as the refundable balance in escrow.

The Affiliate TPP Contract 312 mints an Affiliate TPP to the address linked to an affiliate, if provided, when the customer purchased the item and was minted their own Customer TPP. The owner of the Affiliate TPP will be able to withdraw the affiliates position (commission) upon redemption. Further, the Funder TPP Contract 314 mints a Funder TPP to any address that paid the Raise Amount requested for the item. This amount is forwarded to the store's Funded Vault 306 so the store can withdraw it. The owner of this Funder TPP will be able to withdraw the funders position (principle plus accrued interest) upon redemption of the TPP. The TPP is an NFT that relates back to metadata held within the corresponding chain of contracts and acts as a key to a position held in an Order Escrow, which is created whenever an item is ordered. A position is the right to execute certain functions within the system as well as the right to a percentage of funds held in the Order Escrow based on the metadata it relates to in the various contracts as referenced above.

For further understanding, FIG. 4 depicts the process for order placement and TPP minting. As shown, the order process begins when a Customer 400 submits an order (or pre-order). The Main Contract 302 handles most interactions with the users (including the Customer 400), either directly or via an SDK. In an order scenario, the Main Contract 302 forwards instructions to the store's Store Contract 308 to execute the transaction. The Store Contract 308 creates an Order Escrow Contract 402 for each item in a Customer's 400 online cart. The Order Escrow Contract 402 holds the retail order's funds isolated from all other orders until the Customer's TPP is redeemed as well as instructs the TPP contracts to issue TPPs to the appropriate parties as applicable. The Order Escrow Contract 402 (i.e., a smart contract) is referred to as an escrow because it holds the customers crypto currency used for the purchase and it is isolated from any other transactions because the Store Contract 308 created it on demand for just this transaction. For the customer 400, this is a set amount, the purchase price.

As noted above, the Customer TPP Contract 310 mints a Customer TPP 404 to the Customer 400. This Customer TPP 404 acts as the key to the Customer's 400 position in the Order Escrow that was created at the moment the item was purchased (e.g., 100% of the balance of the Order Escrow 402).

The Affiliate TPP Contract 312 mints an Affiliate TPP 406 to the Affiliate 408, if applicable. This Affiliate TPP 406 acts as the key to the Affiliates '408 position in the Order Escrow Contract 402 that was created at the moment the item was purchased by the Customer 400 (e.g., a predefined commission, such as 10%, for referring the Customer 400 to the store to make the purchase). In this aspect, individuals (i.e., an affiliate/marketer) may choose to promote a store's items for a percent of the sale generated by the system linking the sales transaction represented by the Affiliate TPP 406 to themselves via a special link or affiliate program knowing that compensation for their marketing contribution is secure in escrow. Thus, the affiliate/marketer 408 may promote the product on their own site or feed and, in turn, receive an Affiliate TPP 406 when a Customer 400 clicks through their promotional material and places the pre-order (resulting in generation of the Customer TPP 404). For the Affiliate 408, the Affiliate TPP 406 represents the Affiliate's 408 position for the transaction, which is a redeemable set amount agreed upon for the commission (i.e., 10% of the purchase amount).

Finally, the Funder TPP Contract 314 mints a Funder TPP 410 to the Funder 412, if applicable. The Funder TPP 410 acts as the key to the Funder's 412 position in the Order Escrow Contract 402 that was created at the moment the item was purchased by the Customer 400. The Funder TPP 410 is only issued if the Raise Amount is greater than zero and that amount was sent to the Funded Vault 306 to fund production of that item. Thus, in this scenario, the Funded Vault 306 receives the funds for the store from the Funder 412, if any. In such a scenario, the store can then withdraw funds for production of the item as needed.

By uploading information about an item to the system and generating a TPP upon the placement of an order for the item, the e-commerce store can show that it has legitimate sales with funds held in escrow. Funders 412 can then invest in the production and delivery of the item purchased represented by the TPP. Funders 412 can realize a good ROI without risking large sums of money. Items are fundable down to the individual SKU sold. Newer stores may provide a higher rate of return for higher risk to the Funder 412, whereas more established stores with a better track record might offer lower rates of return for less risk. Making a product fundable is optional. This mechanism would provide liquidity to the store to perhaps manufacture the product if this is a pre-sale or to provide greater cash flow to ramp up production for a popular product without having to go to a bank or take out a loan.

Essentially, a store with a new product or concept with little to no funding or marketing team could crowd source both the funding and marketing. The Funders 412 and Affiliates 408 both know that their eventual payout is held securely in escrow (via the Order Escrow Contract 402). This is enabled by the e-commerce system which records the transaction and provides this information to the TPP contracts so that each TPP minted for a transaction are related to each other through this metadata such as: the TPP's unique id, the TPP Contract address, the Product unique id, the address to the Main Contract 302, the address to the Main Store Contract 308, the Order Escrow address, the Customer TPP 404 unique id, the Funder TPP 410 unique id and the Affiliate TPP 406 unique id. By this relational metadata a TPP is mapped to the order, the escrow, the other related TPPs minted and all the smart contracts utilized in it's creation, granting certain rights to execute functions within the system's various smart contract on the holder's behalf.

Customers 400 can order or preorder items knowing that their funds will not be released to the store or anyone else until they redeem the Customer TPP 404. In the meantime, they can sell/swap/trade the TPP as any other NFT on whatever network the contract is deployed, cancel the transaction for a full refund or even, borrow against the Customer TPP 404 that is backed by the funds in escrow, allowing them flexibility while they wait for the respective TPP to be redeemable by the store. A type of layaway program is possible in this same manner of placing a small percent of the required amount and a third party covering the difference. In such a case, the Customer TPP 404 representing the ordered item is issued to the third party, not the Customer 400. The third party could then sell/swap/trade the Customer TPP until the Customer 400 has paid the full amount for the Customer TPP plus any interest. The individual in possession of the Customer TPP receives the interest paid and the Customer TPP 404 is then transferred to the Customer 400 to be redeemed.

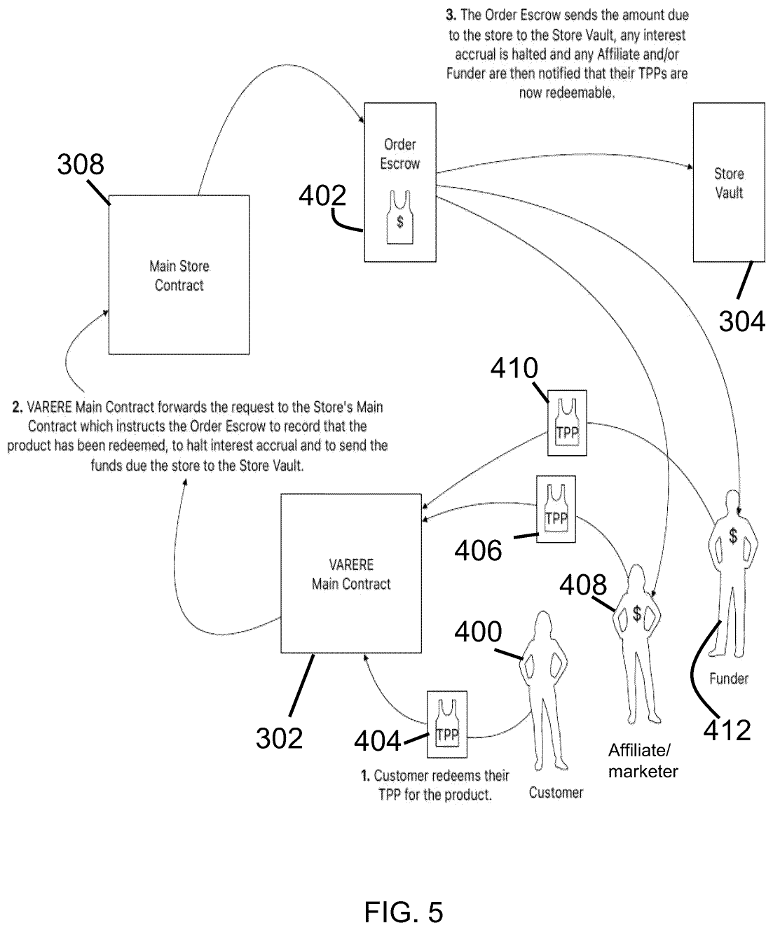

With the item produced, the various parties may redeem their TPPs. For example and as shown in FIG. 5, the Customer 400 may redeem the Customer TPP 404 for the product by submitting a redemption request through the Main Contract 302. In a redemption scenario, the Main Contract 302 forwards the relevant request to the proper Store Contract 308.

The Store Contract 308 records that the Customer TPP 404 has been redeemed for the item and instructs the Order Escrow Contract 402 to halt any accrual of interest due the Funder 412 and to send the funds due to the store to the Store Vault 304. The Order Escrow Contract 402 then holds the remaining balance until the Affiliate 408 and/or

Funder 412, if any, redeem their TPPs. Once the Order Escrow Contract 402 is empty it's destroyed.

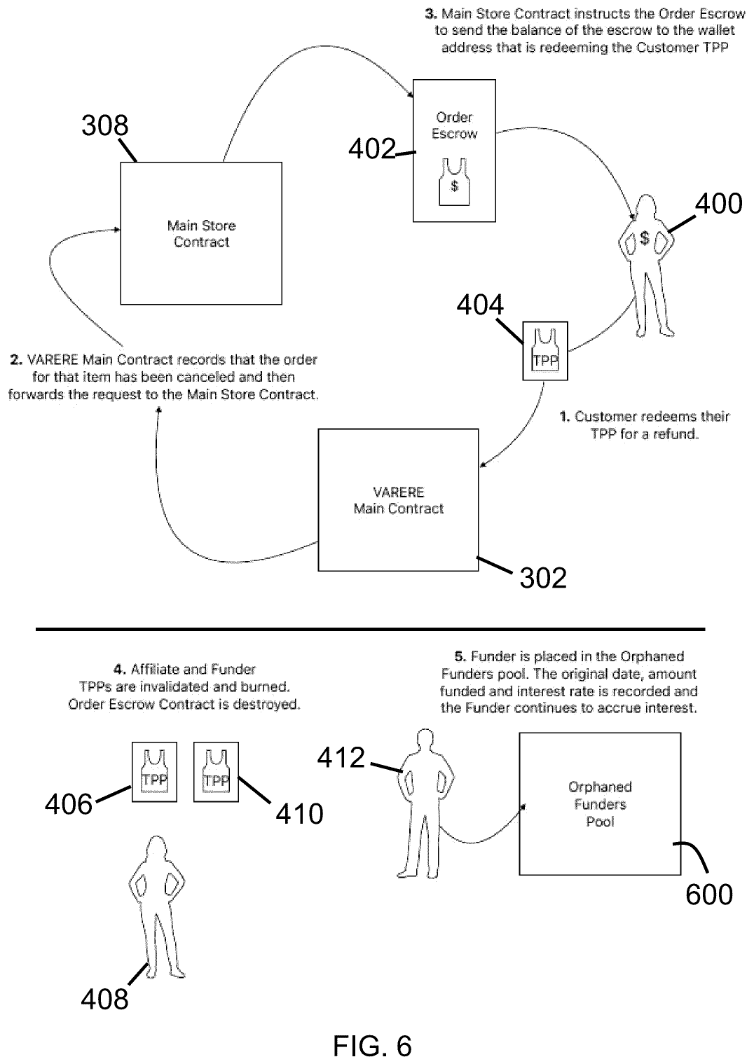

As shown in FIG. 6, in some scenarios, a Customer 400 may redeem the Customer TPP 404 for a refund by submitting a refund request through the Main Contract 302. In a redemption for refund scenario, the Main Contract 302 forwards the request to the proper Store Contract 308 which records that the order for the item has been canceled. The Store Contract 308 then instructs the Order Escrow Contract 402 to send the balance in escrow to the wallet address of the individual Customer 400 redeeming the Customer TPP 404 for a refund. The Store Contract 308 then instructs the TPP Contracts (depicted in FIG. 3) to burn the Customer TPP 404 as well as the Affiliate TPP 406 and Funder TPP 410, where applicable. At this point the Store Contract 308 then destroys the Order Escrow Contract 402 as it no longer holds any funds and the item has been canceled. The Affiliate 408 no longer gets a commission because the order for the item has been cancelled with the associated Affiliate TPP 406 being burned or otherwise destroyed.

In some cases, the system can be designed such that the Funders 412 are issued a refund on their investment upon cancellation. In other scenarios, the system can be designed such that it includes an Orphaned Funders 'Pool 600. In such a scenario, the Funders 412 are held in the Pool 600 until assigned to a new like item transaction (another item from the same collection). The original date, amount funded and predefined interest rate is recorded and the Funder 412 continues to accrue interest. The Funders 412 from the pool get assigned to the next like item transaction (FIFO) and receive new Funder TPPs for those funding positions.

For further understanding, provided below is a non-limiting example of a process by which a store raises funds to produce and sell a sweatshirt. In this example, the dollar amounts are represented as the equivalent in crypto currency. In this scenario, a store has a new sweatshirt (i.e., product) that they have designed. The store lacks the funds necessary to produce the item and, in this example, it will take a year to have the deliverables ready to ship. The store uploads information about the product to the blockchain via the system along with product image(s) and lists the item as available for pre-sale for $40 each. In doing so, the store owner would register products with the Main Contract 302, which in turn creates the Store Contract 308.

After listing the item for pre-sale, a few customers ordered 10 sweatshirts. The system implementing the invention (and associated Customer TPP contract 310) mints 10 Customer TPPs 404 representing each transaction in exchange. The store now has 10 sweatshirts sold and the funds from the customer are in escrow.

When a Customer 400 orders or pre-orders an item, the Main Contract 302 forwards the order information to the Store Contract 308, which creates an escrow smart contract (i.e., the Order Escrow Contract 402) for that transaction and the Customer TPP Contract 310 then issues a Customer TPP 404 to the Customer 400 for 100% of the escrow balance (for potential refund). The Affiliate TPP Contract 312 then mints the Affiliate TPP 406 for the Affiliate 408, if there is one, for a percentage of the purchase price. That commission percentage is set by the store owner for that item. If the item is marked as “fundable”, a Funder 412 can opt to fund production of that item that has been pre-sold for an annual percentage yield (APY), also set by the store owner for that item. If a Funder 412 opts to fund that pre-sale, they are then issued a Funder TPP 410 for that principle plus accrued interest position.

A couple of Affiliates 408 perusing the system see that the store has a new sweatshirt for sale but has only sold 10 so far. The store is offering anyone (e.g., affiliates/marketers/influencers) a commission of 10% annual percentage yield (APY) of retail to promote it. The Affiliate 408 then sells another 90 sweatshirts to their followers by directing them (e.g., via a link) to the product in the store. The new orders cause the Store Contract 308 to generate a new Order Escrow Contract 402 for each item sold, with the associated TPP contracts creating a Customer TPP 404 (representing a Customer's 400 position, which is an order for one item) and Affiliate TPP 406 (representing the Affiliate's 408 position, which is a commission payment upon completion of the order). All funds flow into each Order Escrow. A handful of funders see that the store has now pre-sold 100 sweatshirts and that $4,000 is now in escrow. The store is requesting $20 per item to be funded and offering a return of 30% APY. Various Funders 412 fund all 100 transactions, providing the store the $2,000 needed to produce the sweatshirts. As a result of funding the 100 transactions, the Funders 412 are each provided with associated Funder TPPs 410. Thus and as was the case above, each Funder TPP 410 represents the Funder's 412 position for funding an item, which is generally the payment of principal and interest upon completion of the order.

Once the store has produced the sweatshirts, the TPPs are now redeemable. All 100 TPPs are redeemed and the products are shipped. The Order Escrow Contract 402 sends $2,600 in total to any Funders 412, which is the principle plus interest for their investment. Affiliates 408 are sent $360 worth of commissions for the 90 sweatshirts they helped sell and finally the store is sent $1,040 net from escrow. As evident above, the e-commerce system of the present disclosure allowed the store to raise funds to produce and sell an item, while also allowing investors to participate and receive a return on investment. Further, other third-party affiliates (i.e., marketers/influencers) were motivated through suitable compensation to assist the retailer in marketing the product. This ecosystem that brings together funders, retailers, consumers, and marketers is unique and provides a novel mechanism by which those that participate can mutually benefit.

Again this is all made possible by the invention of the present disclosure implemented as a group of inter-related smart contracts executed by nodes of a blockchain. The flexibility allotted by tokenizing various positions in a secure escrow contract based on these three distinct roles in a transaction and properly dispersing funds to these relevant parties, clearly illustrates the versatility of this innovative invention.

It should be understood that although the invention has been described with respect to the pre-order and production of a product, the invention is not intended to be limited thereto and can be applied to any product, service, investment, project or order in which customers, marketers, and/or funders can be utilized. For example, a project or order does not have to be a pre-order or proposed project, or even be fundable. A standard order without any funding can just mint the TPPs and redeem them immediately by implementing the invention within an e-commerce system. In such an aspect, everyone using said system still benefits from the transparent nature of wrapping the transaction in TPPs. Thus, the system can be employed for other e-commerce and TPP applications.

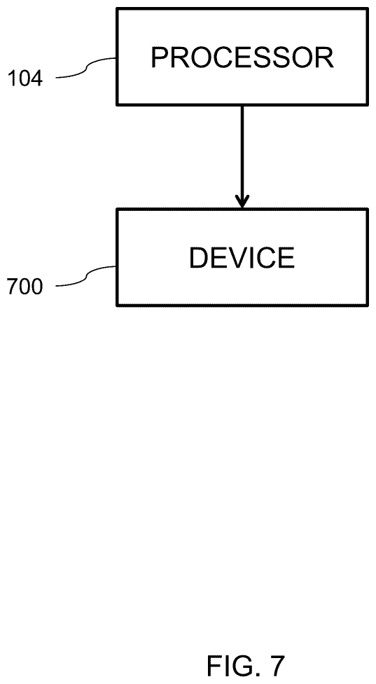

In addition to facilitating funding, production, and marketing of a product or project, the system can also be used to control a device. As shown in FIG. 7, a processor 104 may be used to control a device 700 (e.g., a manufacturing machine, a printer, etc.) based on performing the operations as described herein. The device 700 may be controlled to cause the device to move or otherwise initiate a physical action based on the selected processes. For example, the device 700 may be smart machine within a factory that initiates and begins production of the pre-ordered product upon minting of the Consumer TPP. In another aspect, the device 700 may be a printer that is caused to print out a delivery label for shipping a product upon completion of the product.

Further and as can be appreciated by those skilled in the art, the invention includes any necessary components and/or code as is needed to implement the operations as illustrated and described herein. Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A distributed e-commerce system using a tokenized proof-of-position (TPP), comprising:
one or more processors and associated memory, each memory being a non-transitory computer-readable medium having executable instructions encoded thereon, such that upon execution of the instructions, the one or more processors, in the aggregate, perform operations of:
creating, by a Main Contract, a Store Vault, a Funding Vault, and a Store Contract for an e-commerce store;
receiving, in the Main Contract, predefined terms of a fundable project by a company;
generating, by the Store Contract, a first TPP Contract;
receiving, in the Main Contract, an order by a first party for the fundable project;
generating, by the Store Contract, an Order Escrow Contract for the order; and
generating, by the first TPP Contract, a first TPP for the first party.

2. The distributed e-commerce system using the TPP as set forth in claim 1, further comprising operations of:
receiving funding, by at least one second party, funds for completion of the fundable project per predefined investment terms;
generating, by a second TPP Contract, a second TPP for the at least one second party; and
transmitting the funds to a Funded Vault associated with the company.

3. The distributed e-commerce system using the TPP as set forth in claim 2, wherein the order is a pre-order for a product, the first party is a consumer, and the at least one second party is a funder, the funder providing funds for completion of the pre-order.

4. The distributed e-commerce system using the TPP as set forth in claim 3, wherein the consumer placed the order through an internet link to the Main Contract as placed by a third-party affiliate, such that upon generation of the Order Escrow Contract for the order, a third TPP is generated for the third-party affiliate.

5. The distributed e-commerce system using the TPP as set forth in claim 4, wherein upon completion of the predefined terms of the fundable project, redeeming one or more of the first, second and third TPPs.

6. The distributed e-commerce system using the TPP as set forth in claim 5, wherein upon redemption of the first TPP, instructions are provided to the company to ship the product to the consumer.

7. The distributed e-commerce system using the TPP as set forth in claim 6, wherein upon redemption of the second TPP, transmitting a funder payment to the funder per the predefined investment terms.

8. The distributed e-commerce system using the TPP as set forth in claim 7, wherein upon redemption of the third TPP, transmitting a affiliate payment to the third-party affiliate per predefined terms of the third TPP.

9. The distributed e-commerce system using the TPP as set forth in claim 1, wherein the order is a pre-order for a product, the first party is a consumer, and wherein the consumer placed the order through an internet link to the Main Contract as placed by a third-party affiliate, such that upon generation of the Order Escrow Contract for the order, a third TPP is generated for the third-party affiliate.

10. The distributed e-commerce system using the TPP as set forth in claim 1, wherein upon completion of the predefined terms of the fundable project, redeeming the first TPP, such that upon redemption of the first TPP, instructions are provided to the company to ship the product to the consumer.

11. A computer program product for a distributed e-commerce system using a tokenized proof-of-position (TPP), the computer program product comprising:
one or more non-transitory computer-readable medium having executable instructions encoded thereon, such that upon execution of the instructions by one or more processors, the one or more processors, in the aggregate, perform operations of:
creating, by a Main Contract, a Store Vault, a Funding Vault, and a Store Contract for an e-commerce store;
receiving, in the Main Contract, predefined terms of a fundable project by a company;
generating, by the Store Contract, a first TPP Contract;
receiving, in the Main Contract, an order by a first party for the fundable project;
generating, by the Store Contract, an Order Escrow Contract for the order; and
generating, by the first TPP Contract, a first TPP for the first party.

12. The computer program product as set forth in claim 11, further comprising instructions for causing one or more processors to perform operations of:
receiving funding, by at least one second party, funds for completion of the fundable project per predefined investment terms;
generating, by a second TPP Contract, a second TPP for the at least one second party; and
transmitting the funds to a Funded Vault associated with the company.

13. The computer program product as set forth in claim 12, wherein the order is a pre-order for a product, the first party is a consumer, and the at least one second party is a funder, the funder providing funds for completion of the pre-order.

14. The computer program product as set forth in claim 13, wherein the consumer placed the order through an internet link to the Main Contract as placed by a third-party affiliate, such that upon generation of the Order Escrow Contract for the order, a third TPP is generated for the third-party affiliate.

15. The computer program product as set forth in claim 14, wherein upon completion of the predefined terms of the fundable project, redeeming one or more of the first, second and third TPPs.

16. The computer program product as set forth in claim 15, wherein upon redemption of the first TPP, instructions are provided to the company to ship the product to the consumer.

17. The computer program product as set forth in claim 16, wherein upon redemption of the second TPP, transmitting a funder payment to the funder per the predefined investment terms.

18. The computer program product as set forth in claim 17, wherein upon redemption of the third TPP, transmitting a affiliate payment to the third-party affiliate per predefined terms of the third TPP.

19. The distributed e-commerce system using the TPP as set forth in claim 11, wherein the order is a pre-order for a product, the first party is a consumer, and wherein the consumer placed the order through an internet link to the Main Contract as placed by a third-party affiliate, such that upon generation of the Order Escrow Contract for the order, a third TPP is generated for the third-party affiliate.

20. The computer program product as set forth in claim 11, wherein upon completion of the predefined terms of the fundable project, redeeming the first TPP, such that upon redemption of the first TPP, instructions are provided to the company to ship the product to the consumer.

21. A computer implemented method for a distributed e-commerce system using a tokenized proof-of-position (TPP), the method comprising acts of:
causing one or more processers to execute instructions encoded on associated non-transitory computer-readable medium, such that upon execution, the one or more processors, in the aggregate, perform operations of:
creating, by a Main Contract, a Store Vault, a Funding Vault, and a Store Contract for an e-commerce store;
receiving, in the Main Contract, predefined terms of a fundable project by a company;
generating, by the Store Contract, a first TPP Contract;
receiving, in the Main Contract, an order by a first party for the fundable project;
generating, by the Store Contract, an Order Escrow Contract for the order; and
generating, by the first TPP Contract, a first TPP for the first party.

22. The computer program product as set forth in claim 21, further comprising acts of causing one or more processors to perform operations of:
receiving funding, by at least one second party, funds for completion of the fundable project per predefined investment terms;
generating, by a second TPP Contract, a second TPP for the at least one second party; and
transmitting the funds to a Funded Vault associated with the company.

23. The computer program product as set forth in claim 22, wherein the order is a pre-order for a product, the first party is a consumer, and the at least one second party is a funder, the funder providing funds for completion of the pre-order.

24. The computer program product as set forth in claim 23, wherein the consumer placed the order through an internet link to the Main Contract as placed by a third-party affiliate, such that upon generation of the Order Escrow Contract for the order, a third TPP is generated for the third-party affiliate.

25. The computer program product as set forth in claim 24, wherein upon completion of the predefined terms of the fundable project, redeeming one or more of the first, second and third TPPs.

26. The computer program product as set forth in claim 25, wherein upon redemption of the first TPP, instructions are provided to the company to ship the product to the consumer.

27. The computer program product as set forth in claim 26, wherein upon redemption of the second TPP, transmitting a funder payment to the funder per the predefined investment terms.

28. The computer program product as set forth in claim 27, wherein upon redemption of the third TPP, transmitting a affiliate payment to the third-party affiliate per predefined terms of the third TPP.

29. The distributed e-commerce system using the TPP as set forth in claim 21, wherein the order is a pre-order for a product, the first party is a consumer, and wherein the consumer placed the order through an internet link to the Main Contract as placed by a third-party affiliate, such that upon generation of the Order Escrow Contract for the order, a third TPP is generated for the third-party affiliate.

30. The computer program product as set forth in claim 21, wherein upon completion of the predefined terms of the fundable project, redeeming the first TPP, such that upon redemption of the first TPP, instructions are provided to the company to ship the product to the consumer.
